(19) United States
(12) Patent Application Publication
(10) Pub. No.: US 2005/0167383 A1
(43) Pub. Date: Aug. 4, 2005

(54) Merchandise display rack

(76) Inventors: Raymond Taccolini, San Clemente, CA (US); Jim Kaczmarek, Murrieta, CA (US); Victor J. Triana, Mission Viejo, CA (US); Larry J. Swingholm, Mission Viejo, CA (US)

Correspondence Address: STETINA BRUNDA GARRED & BRUCKER, 75 ENTERPRISE, SUITE 250, ALISO VIEJO, CA, 92656, US

(21) Appl. No.: 10/878,201

(22) Filed: Jun. 28, 2004

Related U.S. Application Data
(60) Provisional application No. 60/540,753, filed on Jan. 31, 2004.
(60) Provisional application No. 60/573,905, filed on May 24, 2004.

(51) Int. Cl. B42F 1/00; A47B 43/00; A47B 47/00

(52) U.S. Cl. 211/189

(57) ABSTRACT

A display rack on a store aisle is mounted to upper and lower frames which are adjustable in length along the aisle and adjustable in depth perpendicular to the aisle to mount the display rack at a desired location along the aisle and perpendicular to the aisle. The frames are each fastened to two posts adjacent the aisle, using a rear member of each frame to connect to the posts. The frames have front, rear and end members that may be disassembled for shipment, and that are each adjustable in length. The display rack is filled with merchandise before it is fastened to the frames.

### RELATED APPLICATIONS

This application claims the benefit under 35 U.S.C. § 119(e) of Provisional Application Ser. No. 60/540,753, filed Jan. 31, 2004 and Ser. No. 60/573,905, filed May 24, 2004, the entire contents of which are hereby incorporated by reference.

### BACKGROUND

This invention relates to a method and apparatus for displaying merchandise in retail outlets, particularly where the merchandise is hung from rods for display.

Stores use display racks to hold and display merchandise for purchase. Merchandise is often packaged so that it hangs from rod-like hooks that are individually placed into a pegboard. The pegboard allows the individual hooks to be placed in unique and varying arrangements, but it takes time to do so. It also takes time to hang the merchandise on the hooks as the rod-like hooks must be individually threaded through holes in the merchandise packaging. When large quantities of merchandise is being replaced or stocked a large amount of time is needed but there is typically little time to do so. Thus employees must work overnight, or stores must close for large restocking. There is thus a need for an improved way to stock large quantities of merchandise on hanging hooks.

Further, it is usually desirable to have the merchandise close to the aisle where consumers can more easily inspect and acquire the merchandise, so the hooks from which the merchandise is hung often end very near the aisle. But the pegboard is typically fastened to a wall or metal frame which is positioned far from the aisle. Long rods can be used to place merchandise nearer the aisle but that requires maintaining an inventory of various length rods. Further, the long rods may be too thin to support the merchandise, so a variety of rod diameters must be maintained. There is thus a need for a method and apparatus to allow merchandise racks which use these rod-like hooks to be more easily positioned relative to the aisle and wall or support to which the rack is fastened.

### BRIEF SUMMARY OF THE INVENTION

A display rack on a store aisle is mounted to upper and lower frames which are adjustable in length along the aisle and adjustable in depth perpendicular to the aisle to mount the display rack at a desired location along the aisle and perpendicular to the aisle. The frames are each fastened to two posts adjacent the aisle, using a rear member of each frame to connect to the posts. The frames have front, rear and end members that may be disassembled for shipment, and that are each adjustable in length. The display rack is filled with merchandise before it is fastened to the frames.

In more detail, a display rack for displaying items is provided for racks that are located between two spaced apart posts which support the display rack during use. The display rack includes a first frame having an opposing front and back member. Each front and back member has a longitudinal axis and each has an outer member with an inner member nested inside the outer member and extendable along the longitudinal axis to vary the length of the front and back members along that axis. The back member has two opposed ends each adapted to fasten to one of the post during use. The rack has a second frame having the parts as defined for the first frame. The second frame is below the first frame. The display rack has a frame connected to the front member of the first and second frames and also has a plurality of hooks extending from the display rack to hold the items for display during use of the display rack.

In further variations of the above embodiment, the first frame includes two opposing end members each of which extends along a longitudinal axis of the respective end member and each of which has an outer end member and an end inner member nested inside the outer end member and extendable along the longitudinal axis of the end member to vary the length of the end member. Each end member has two distal ends, one of which is connected to the front member and the other of which is connected to the rear member. In a still further variation, the second frame has two opposing end members as defined for the first frame member.

In a further variation of the above embodiment, at least some and preferably all of the inner and outer members are releasably fastened at a specified length. This is preferably, by optionally achieved by providing each inner and outer member with a plurality of holes extending therethrough with at least some of the plurality of holes located to align as the inner member extends along the longitudinal axis. A fastener extends through the aligned holes to releasably hold the members through which the fastener passes at a selected length. Advantageously, but optionally, each of the end members is releasably connected to the front and back members.

In a further embodiment the invention comprises a kit for assembling a display rack used to display items, where the display rack is placed between two spaced apart posts which support the display rack during use. The kit includes the above components, variations and options, but preferably, and optionally, with the lengthwise adjustable members being collapsed to a smaller configuration for ease of shipping. Moreover, the kit includes a back member with two opposed ends adapted to fasten to the post during use. Further, the display rack frame is adapted to connect to the front member of at least one of the first and second frame, and also has having a plurality of hooks extending from the display rack, with a plurality of items on the hooks of the display rack.

In further embodiment the display rack has an upper frame including an extendable upper front member and an extendable upper back member. The upper back member has opposing ends each of which is adapted to fasten to one of the posts. The upper frame also includes a pair of extendable upper end members each having one end connected to the upper front member and an opposing end connected to the upper back member. The display rack also has a lower frame including an extendable lower front member and an extendable lower back member, where the lower back member has opposing ends each of which is adapted to fasten to one of the posts. The display rack also includes a pair of extendable lower end members each having one end connected to the lower front member and an opposing end connected to the lower back member. Finally, the display rack itself is connected to each of the upper front member and the lower front member.

In further variations of this above embodiment, the display rack has a plurality of hooks extending from the rack. Advantageously, but optionally merchandise is removably fastened to a plurality of the hooks when the display rack is fastened to the front members. Advantageously, but optionally, at least some of the upper and lower end members are releasably connected to the front and rear members. Further, a releasable fastener is provided to fix the lengths of the members after the ends of the rear members are fastened to the posts and after adjusting the length of the ends and members.

A further embodiment of the apparatus is a kit for fastening the display rack to the posts. The kit has an upper frame including a pair of upper end members each having one end adapted to connect to the front post and an opposing end adapted to connect to the rear post. An upper support member has opposing ends each of which is adapted to fasten to a different one of the upper end members a pair of lower end members each have one end adapted to connect to the front post and an opposing end adapted to connect to the back post. A lower support member has opposing ends each of which is adapted to fasten to a different one of the upper end members. A display rack is fastened to the support members, with the rack advantageously, but optionally having a plurality of hooks with merchandise on a plurality of the hooks when the rack is first fastened to the support members. Means are provided for varying the length of each upper and lower end members; upper and lower. Means are provided for fastening the display rack to the upper and lower support members.

Further variations of this embodiment include a brace having opposing ends each configured to connect to a different one of the upper and lower support members, with means for varying the length of the brace and for fastening the brace to the support members. The variations also include a lower support having one distal end configured to connect to the lower support and a length sufficient to extend from the lower support to the floor during use of the kit. Means are provided for varying the length of the lower support member. At least one of the upper and lower support members preferably has a connector with at least three arms two of which are configured to fasten to one of the support members. The upper and lower end members are preferably releasably connected to the front and rear posts.

In a further variation of this embodiment the upper frame comprises a front and rear support each having opposing ends adapted to fasten to a different one of the upper end members and means for varying a length of the front and rear upper support members. The lower frame also comprises a front and rear extendable support each having opposing ends adapted to fasten to a different one of the upper end members and means for varying the length of the front and rear lower support members. The display rack fastens to the front members.

There is also provided a method for positioning a display rack between a first and second pair of posts extending from a floor, with each pair having a front and rear post and each pair being spaced apart along a first axis extending along an aisle adjacent the front post. The rear post is set back from the aisle along a second axis generally perpendicular to the first axis. The method includes adjusting a length of a first upper end member to extend between the first pair of posts and fastening the first upper end member to different ones of the front and rear posts. The method also includes adjusting a length of a second upper end member to extend between the second pair of posts and fastening the second upper end member to the front and rear posts of the second pair.

The method also includes adjusting a length of an upper support member to extend between the first and second upper end members and removably fastening the upper support member to the upper support members. The length of a first lower end member is also adjusted to extend between the first pair of posts and removably fastening the first lower end member to the front and rear posts of that first pair. A length of a second lower end member is adjusted to extend between the second pair of posts and removably fastening the second upper end member to the front and rear posts of that second pair. A length of a lower support member is adjusted to extend between the first and second lower end members and removably fastening the lower support member to the lower support members. The method also includes fastening the display rack to each of the support members, with the display rack preferably, but optionally having hooks thereon with merchandise on a majority of the hooks when the display rack is fastened to the support members. Each of these adjustable parts preferably has two nested parts that slide relative to each other to vary the length of the respective part.

Variations on the method include locking the length of the end members and support members after the length of each member is adjusted. Further, a brace is advantageously removably fastened between the upper and lower supports. An adjustable length connection with at least one of the upper and lower supports is used to vary the length of the brace. A lower support is preferably, but optionally removably fastened to the lower support frame, with the lower support extending between the floor and the lower support frame. An adjustable length connection with the lower supports member is used to vary the length of the lower support so it reaches the floor. The lower support can be used with or without the brace. Adjusting the location of the upper and lower support members along the length of the end members can position the display rack relative to the front posts.

In a further embodiment the upper and lower frames have front and rear supports and the method includes adjusting a length of a rear upper support member to extend between the upper end members and the upper rear support member is removably fastened to the upper end members. The length of a rear lower support member is likewise adjusted to extend between the lower end members and lower rear support member is removably fastened to the upper end members. In a further embodiment the method includes fastening a second display rack to the upper and lower support members, the second display rack having hooks thereon with merchandise on a majority of the hooks when the second display rack is fastened to the support members.

A further method includes placing merchandise on the display rack at a location outside the store. The lengths of an first upper and lower end members are adjusted to extend between the first pair of posts and releasably fastening the first upper and lower end members to the first pair of posts. The lengths of a second upper and lower end member are adjusted to extend between the second pair of posts and the second upper and lower end members are releasably fastened to the second pair of posts. The length of upper and lower support members are adjusted to extend between the respective upper and lower end members and the support members are releasably fastened to the respective end members. The display rack is attached to the upper and lower support members. This further method also preferably includes locking the length of the end members and the upper and lower support members after the length is adjusted. Further variations of this further method include adjusting a location of the upper and lower support members along the length of the end members before or after the display rack is fastened to the support members to position the display rack relative to the front posts.

In a further embodiment, there is provided a method of stocking merchandise on a display rack to be held between two posts adjacent an aisle in a store. This method includes placing merchandise on the display rack at a location outside the store. A rear member of an upper frame is attached to each of the posts, the upper frame being adjustable in the store along a length direction that is parallel to the aisle and adjustable in the store along a depth direction that is perpendicular to the aisle. The method also includes attaching a rear member of a lower frame to each of the posts at a location below the upper frame, where the lower frame is adjustable in the store along a length direction that is parallel to the aisle and adjustable in the store along a depth direction that is perpendicular to the aisle. The method further includes adjusting the location of the upper and lower frames along the depth direction, in the store. Finally, the method includes attaching the display rack to the front members of the upper and lower frames.

In further variations of this embodiment, the method includes adjusting the location along the depth direction occurs after the display rack is fastened to the front members. The method also optionally includes adjusting the location of the front members after the display rack is fastened to the front members. Further, the method includes locking the length of the front members, rear members, and end members of the upper and lower frames after the length is adjusted.

In addition to the above, and further advantages discussed herein, there is advantageously provided a method and apparatus for installing a display rack quickly, and for stocking the display rack quickly, and for accommodating a variety of locations of the display rack easily.

### BRIEF DESCRIPTION OF THE DRAWINGS

These and other advantages and features of the invention will become more apparent in view of the following description and drawings in which like numbers refer to like parts throughout, and in which:

FIG. 1 is a perspective view of an adjustable display rack of this invention mounted on a structural support, with a portion of the display rack cut away;

FIG. 2 is an exploded perspective view of an adjustable frame used on the adjustable display rack of FIG. 1;

FIG. 3 is a partial perspective view of a grid work frame and a mounting clamp as used in FIG. 1;

FIG. 4 is a sectional view taken partially along a longitudinal axis of an end member of FIG. 1 or 2, showing the connection of the nested members and an end member to a rear member, and showing the connection of a grid work frame of a hooked display rack to a front member of the adjustable fame of FIG. 1;

FIG. 5 is a partial sectional view showing the connection of the nested members to the hooked display rack;

FIG. 6 is a partial perspective view of an alternative embodiment of one end of an adjustable frame;

FIG. 7 is a partial sectional view showing an alternative embodiment for connecting an end member to a rear frame member;

FIG. 8 is a partial sectional view showing a further alternative embodiment for connecting an end member to a rear frame member;

FIG. 9 is a partial sectional view showing a further alternative embodiment for connecting an end member to a rear frame member;

FIG. 10 is a partial sectional view showing an alternative embodiment for releasably connecting a hooked display rack to an adjustable frame;

FIG. 11 is a partial sectional view showing an alternative embodiment for releasably connecting a hooked display rack to an adjustable frame using a resilient snap-lock;

FIG. 12 is a rear perspective view of a further embodiment of a display rack having surfaces for displaying printed indicia, such as promotional material, displayed on the rack;

FIG. 13 is an exploded, perspective view of a further embodiment of a portion of a support for a display rack;

FIG. 14 is a perspective view of the support of FIG. 13;

FIG. 15 is a partial sectional view of a display rack mounted to the support of FIG. 13;

FIG. 16 is a perspective view of a further embodiment of a display rack;

FIG. 17 is an exploded perspective view of a further embodiment of a display rack with a single horizontal support; and

FIG. 18 is an exploded view of a further embodiment of a display rack with a single horizontal support and with a fixed length floor support.

### DETAILED DESCRIPTION OF THE INVENTION

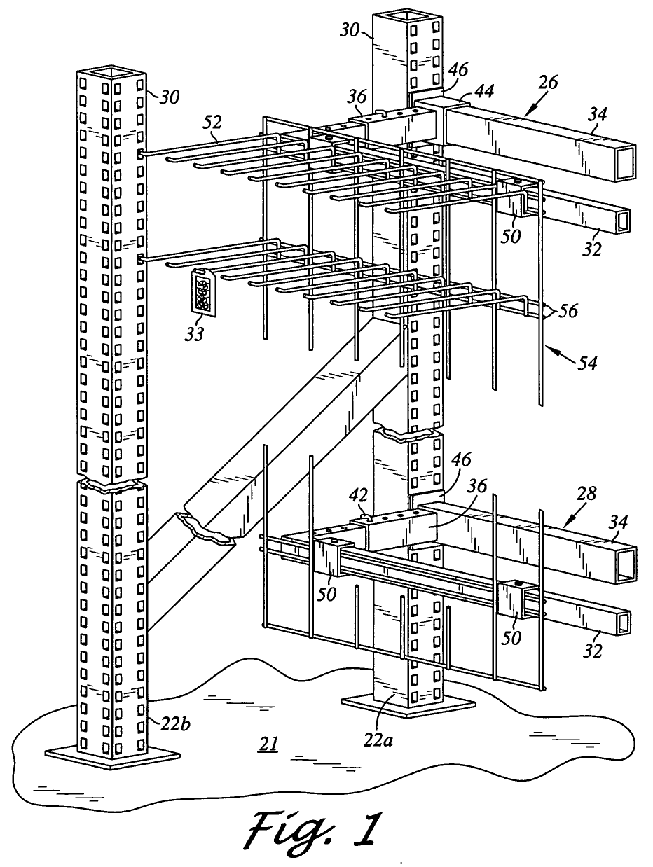

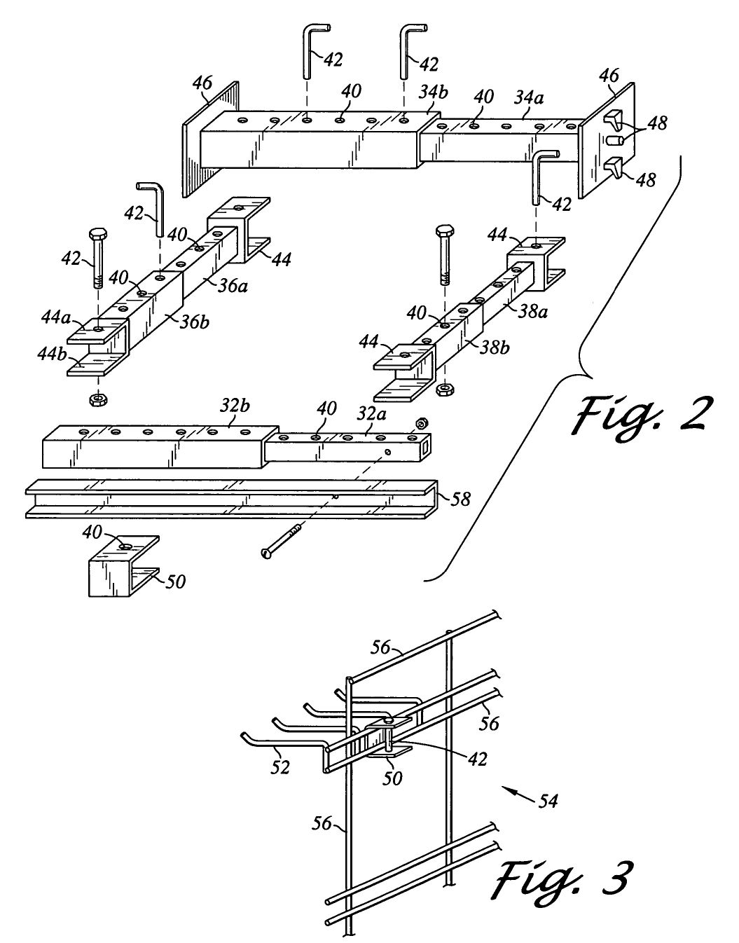

Referring to FIGS. 1-2 an adjustable display rack 20 is fastened to a structural support such as a wall stud, or a vertical support 22 such as a post 22 which rests on or is fastened to a floor 21. Commercial shelving with which this invention is usable includes such units as Interlake steel-framed shelving units. These units have a pair of posts at opposing ends of each shelving segment, with one post on the aisle and one post set in from the aisle. There is thus a pair of supports or posts 22 at opposing ends of a shelving segment with shelving extending between adjacent pairs of posts.

The adjustable rack 20 advantageously has a hooked display rack 24 mounted to upper and lower adjustable frames 26, 28, at the upper and lower ends of the hooked display rack 24, respectively, and these frames 26, 28 fasten to one or more posts 22, and preferably extend between two adjacent pairs of posts 22, so opposing ends of the frames 26, 28 are fastened to one of a different pair of posts. The frames 26, 28 can be varied in size in and along perpendicular directions. The mechanism used to fasten the adjustable rack 20 to the posts 22 will vary, and includes various brackets, releasable fasteners, threaded fasteners, pins, etc.

As used herein, up, upper or above refers to a direction away from the ground or floor 21, or refers to a relative position further in that direction. The terms down, downward or below refer to a direction toward the ground or floor 21, or refer to a relative position further in that direction. The terms forward or front refer to a direction toward the aisle, or refer to a relative position further in that direction. The terms back or rear refer to a direction away from the aisle or refer to a relative position further in that direction.

The posts 22 are spaced apart a distance that will vary with the particular needs. The posts 30 could also be studs of a building in which case the posts are spaced as specified in local building codes. The invention is described relative to posts 22 which are typically spaced further apart than building studs, but the invention is usable with either structural support with suitable modifications. FIG. 1 shows a pair of posts, with rear post 22a and front post 22b fastened together by horizontal and angled members to form a sturdy, stable support. The posts 22 are typically of rectangular cross-section (which includes a square cross-section), and made of metal.

The upper frame 26 and lower frame 28 are similar in construction, so only one is described in detail. Where needed, corresponding parts of each frame 26, 28 will be referred to as upper or lower, respectively, to associate the part with the appropriate frame 26, 28. The frame 26 is preferably, but optionally rectangular so it has opposing front and rear members 32, 34, respectively, fastened to opposing end members 36, 38. The front and rear members 32, 34 are preferably, but optionally parallel and in the same horizontal plane. The end members 36, 38 are also preferably, but optionally parallel and in the same horizontal plane. The frame 26 is thus advantageously, but optionally, in a plane that is preferably horizontal.

The opposing front and rear members 32, 34 are adjustable in length along a longitudinal axis of each member. This adjustment can be achieved several ways, but advantageously is achieved by having two nested members move relative to each other. Referring to FIG. 2 the rear member 34 is a tubular member of two different sizes selected so a smaller sized inner tube 34a nests within a larger sized outer tube 34b. By moving the inner and outer members 34a, 34b relative to each other, the length of the rear member 34 can be adjusted. The rear member 34 is adjusted in length so that it can be fastened between two posts 22, and preferably between two spaced-apart posts 22a. When the desired length is achieved, the relative position of the members 34a, 34b is fixed or fastened in place—other than by fastening the ends to the posts 22.

Various ways can be used to fix or hold in place the adjusted length once a predetermined or desired length is achieved, including spring loaded members on one part extending into detents on the other part, or projections on one part mating with recesses on the other part. In the preferred embodiment a series of holes 40 are formed in through the members 34a, 34b preferably, but optionally at regular intervals, to allow the length of the members 34a, 34b to be adjusted to extend between the adjacent posts 22. A fastener 42 such as a bolt or pin can pass through the aligned holes 40 to fix the members 34a, 34b in position relative to each other. Further, a single hole 40 could be formed in one part and a plurality of holes 40 in the mating part. Thus, at least one of the mating parts have a plurality of holes 40 which align with a hole 40 in the other of the mating parts to adjust the length of the mated parts, with a fastener 42 inserted through the aligned holes to fasten the mated parts together at the selected length. This basic concept is preferably used to adjust the length of the various parts herein.

The fasteners 42 are preferably of the type that has a positive lock to prevent unintentional removal. A cotter key, nut, or other retention device is thus preferably, but optionally used to prevent removal of the fastener 42 after it extends through the mating parts 34a, 34b to fix the relative position and length of those parts. The relative position could also be fixed by deforming the parts, or by adhesives, removable tape, or other ways known to those skilled in the art.

The front member 32 is also of adjustable length so the front member 32 can extend a desired length appropriate to hold one or more hooked display racks 24 fastened to the front member, as described later. The display rack 24 can take a variety of sizes and shapes. The front member 32 is advantageously constructed in the same manner as the rear member 34, so it has inner member 32a nested inside outer member 32b and locked or held into position by fastener 42 extending through aligned holes formed in the telescoping parts 32a, 32b. The front member 32 does not carry as much force as the rear member 34. Thus, the front member 32 preferably, but optionally, is not as strong as the rear member 34. The front member 32 can thus have a smaller cross-section than the rear member 34.

The front and rear members 32, 34 preferably, but optionally have a closed cross section, with rectangular cross-sections being preferred. But other cross sectional shapes could be used, including circular or triangular cross sections. Open sections such as C channels could be used, but they are less desirable because they are not as strong. The specific shape of the cross-section and the size of the nested members 32a, 32b, 34a, 34b, will vary depending on the weight carried by these parts.

The end members 36, 38 are also adjustable in length. These end members 36, 38 are advantageously constructed like the rear member 34 and the construction and options on construction are not repeated in detail. The end members 36, 38 thus have inner members 36a, 38a, slidably received in outer members 36b, 38b, with a plurality of holes 40 extending through the parts so that one or more fasteners 40 can pass through the aligned holes to hold the members 36a, 36b and 38a, 38b in position relative to each other when the desired length of the end members 36, 38 is achieved. The cross-sectional shape of end members 36, 38 is the same as, or similar to those of members 32, 34.

The end members 36, 38 are connected to the front and back members 34, 36 to form a frame that is preferably, but optionally rectangular in shape and planar. One or both of the distal ends of the end members 36, 38 can be welded to the adjacent distal end of the front and rear members 34, 36. Alternatively flanges could be provided to the distal ends of the end members 36, 38 and a bolted connection could be used. Combinations of welded and bolted connections could be used. Removable connections are preferred to permanent connections like welding. One bolted connection which allows removable, adjustable positioning of the end members 36, 38 is shown in FIG. 2. The construction of the connection is similar for each end member so only one is described in detail.

A C-shaped coupling 44 is provided having opposing flanges 44a, 44b extending from a distal end of end member 36 or 38. The couplings 44 need not be provided on each distal end of the end members 36, 38. One distal end of the end members 36, 38 could be welded to the mating front or rear member 32, 34. The coupling 44 can thus be welded or bolted to one or both distal ends of member 36 or 38. The couplings 44 are shaped to mate with the adjacent member 32 or 34. Advantageously, when the members 32, 34 have rectangular cross-sectional shapes, the flanges 44a, 44b are parallel, and horizontal. The flanges 44a, 44b are advantageously spaced apart a distance selected so they accept, and preferably mate with the opposing top and bottom sides of one of members 32, 34. The couplings 44 have one or more aligned holes 40 extending through them so a fastener 40 can pass through the couplings 44 and aligned holes 40 in one of members 32, 34 to fasten the couplings to the mating member.

Putting a coupling 44 on opposing distal ends of a single end member 36, 38 allows the location of that end member to be varied along the length of the front and rear members 32, 34. Preferably, but optionally, the end members 36, 38 are fastened to the front and rear members 32, 34 adjacent the distal ends of the members 32, 34. Specially located, sized or shaped holes 40 can be provided on the couplings 44 and at the distal ends of front and rear members 32, 34 to allow easy placement and joinder of the ends 36, 38 to the front and rear members 32, 34. Moreover, while the couplings 44 are described as being mounted to the distal ends of end members 36, 38, the couplings could be fastened to the front and/or rear members 32, 34 in fixed or selectable locations, and sized to receive the distal ends of the end members 32, 34 between the couplings.

The front and rear members 32, 34 and the end members 36, 38 thus form an upper frame 26 which can be adjusted in length to accommodate different spacings between posts 22. The ends 36, 38 may be adjusted in length to vary the distance between the front and rear members 32, 34. That is useful because the rear member 34 is fastened to the post 22 so the adjustable length of end members 36, 38 allows the front member 32 to be positioned closer to or further from the aisle. A similar construction is used for the lower frame 28, so the details of construction and variations on construction of lower frame 28 are not repeated.

Referring to FIGS. 1-2, each distal end of rear member 34 has a mounting flange 46 fastened thereto. The mounting flange is shown as comprising a rectangular plate welded to the distal end of the member 34, and perpendicular to the longitudinal axis of the rear member 34, but the flange could be located elsewhere depending on the nature of the attachment to the post 22. The mounting flange 46 preferably, but optionally, has one or more mating connectors 48 extending therefrom configured to mate with corresponding connectors or recesses in post 22. If the posts 22 are the conventional posts made by Interlake, then the posts 22 have shaped holes and the connectors 48 comprise either cylindrical projections, or lugs with an overhang that extend into and engage the edges of the recesses in the post 22.

The orientation and configuration of the flange 46 will vary with the nature of the connection to the post 22, and with the nature of the post 22. Alternatively, the flange 46 could be bolted to the post 22, and the orientation of the flange 46 could be altered to fasten to other faces of the post 22. The mounting flange 46 could be omitted and a bolt or other fastener could pass through the distal end of rear member 32 to fasten the member 32 to the post 32.

If there are two posts, one rear post 22a and one front post 22b which are connected by braces as is common and as shown in FIG. 1, then the rear member 32 is preferably fastened to the rear post 22a. That allows the ends 36, 38 to position the front member 34a desired distance to the aisle which will be near or at the front post 22b. It is believed possible to mount the frame(s) 26, 28 to the front post 22b and have the front members 22 cantilevered away from the aisle by the frames, but that is believed less desirable.

Referring to FIGS. 1 and 3 the hooked display rack 24 is fastened to the front member 32 of at least one of the upper and lower adjustable frames 26, 28. Preferably the hooked display rack 24 is fastened to the front member 32 of each of the upper and lower adjustable frames 26, 28. The hooked display rack 24 can be fastened to the front member(s) 32 various ways, including through the use of various clamps and threaded fasteners, which will be referred to herein as clamps.

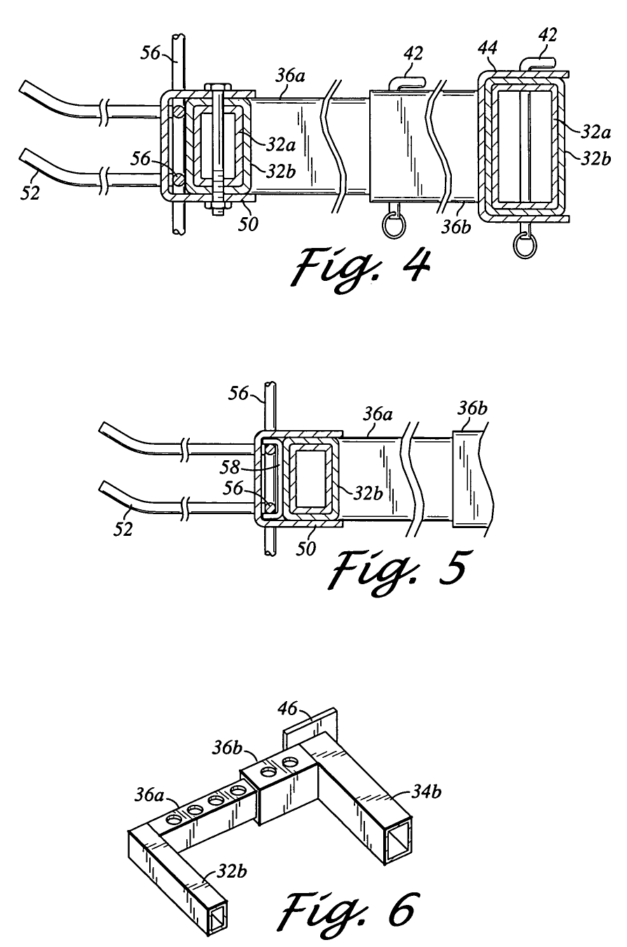

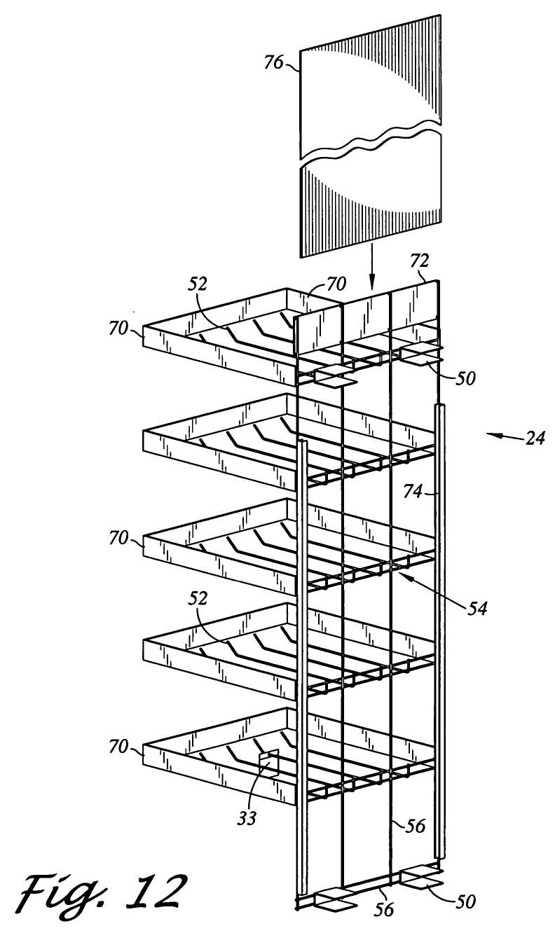

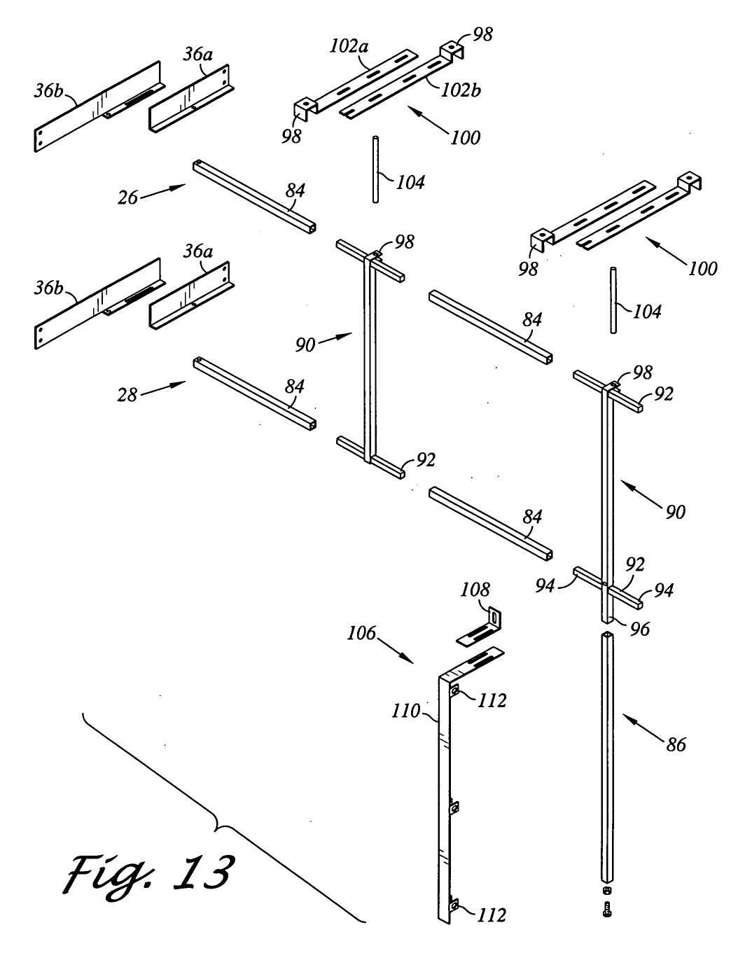

FIGS. 1, and 3-5 show one suitable clamp 50 taking the form of a C-shaped clamp with two parallel flanges having an aligned hole or holes 40 in the opposing flanges. The clamp 50 may be permanently fastened to the display rack 24, as by welding and as shown in FIG. 12, or it may be removably fastened. The removable version is described as it is more complicated. The Clamp 50 is sized to the flanges fit over the sides of the front member 32 with a portion of the hooked display rack 24 being located between the clamp and the front member 32. Passing a fastener 42 through the holes 40 in the clamp 50 and the front member 32, the rack 24 is releasably held to the front member 32. Advantageously each display rack 24 is held by two clamps to the upper front member 32 and held by two clamps to the lower front member 24.

Referring to FIGS. 2 and 5, a further embodiment of the clamp 50 is shown. In this embodiment the hooked display rack 24 has a plurality of hooks 52 extending from a planar grid work frame 54. The grid work frame is shown as having a plurality of rod-like hooks 52 arranged in horizontal rows and vertical columns in a generally vertical plane, and fastened together at the intersections. Advantageously the rows of rod-like hooks are formed by pairs of closely spaced rods 56 with each such pair separated by a larger space, and with the base of the hooks fastened to each pair of rods for extra strength and support. The hooks 52 are preferably, but optionally, permanently fastened to the frame 54, and are also advantageously all of the same length.

An elongated channel 58 having a C-shaped cross-section is fastened to the front face of the front member 32, by welding, threaded fasteners, pins, adhesives, or other means known to those skilled in the art. One of the horizontal pairs of rods 56 is fit inside the C-shaped channel 58 so the channel supports the rods 56 and connected display rack 24 vertically. Placing a slight lip on the channel 58 would help retain the rod 56 in the channel 58. The C-shaped clamp 50 is then placed over the channel 58 and front member 32 to trap the rods 54 and channel 58 between the front member 32 and the clamp 50. The clamp 50 is then removably fastened to the front member 32, as by a fastener 40 extending through aligned openings 40 in the clamp 50 and the front member 32. The lower leg of the C-shaped channel 58 provides a ledge or support for holding the rod 56 and the rack 24 connected to the rod. The clamp 50 prevents the rod 56 and associated rack 24 from pulling away from the front member 32. Other ways of removably fastening the hooked display rack 24 to the front member(s) 32 are known and would also work. The same connection or different connections can be used to fasten the hooked display rack 24 to both the top and bottom front members 32.

In use, the posts 22 are set at predetermined locations, usually determined by the merchant displaying merchandise 33 (FIG. 1). The back members 34 are adjusted to length between two posts 22, and fastened to those posts. The front members 32 are then adjusted to the desired length, and fastened to the back members 34 by end members 36, 38. The length adjustment of front member 32 can occur after the front member 32 is fastened to the back member 34, or the length can be adjusted both before and after the front member 32 is fastened to the back member 34. The end members 36, 38 are then adjusted in length to position the front members 32 at a desired distance from the aisle. The length adjustment may be an iterative process for each of the members 32, 34, 36 and 38. The hooked display rack 24 is then fastened to the front member(s) 32. Further length adjustments may be made as needed to position the rack 24 at the desired location. The hooked display rack 24 could be fastened to the front members 32 before the length of the end members 36, 38 are adjusted.

The display rack 24 is effectively cantilevered from the adjustable length rear member or members 34, along a direction toward the aisle and purchasers who remove items from the display rack 24. As noted, the system could be reversed and fastened to the front post 22b, and cantilevered away from the aisle with the frames 26, 28 located above and below the display rack 24, but that is less desirable.

The length of the cantilever is adjusted by adjusting the length of end members 36, 38, and that adjustment also positions the display rack 24 to the desired position. Since a plurality of display racks 24 can be fastened to the upper and/or lower support frames 26, 28, the weight that needs to be supported can vary significantly. If the hooked display rack 24 or plural racks 24 are heavy when loaded with merchandise 33 (FIG. 1), or if there is a large distance between the posts 22 to which the frames 26, 28 are fastened, then additional support members can be provided between the front and rear members 32, 34. These additional support members can be made like the end members 36, 38, and they effectively increase the number of the cantilever supports for the display rack or racks 24.

The adjustable length of the end members 36, 38 allows the hooked display rack 24 to be placed a desired distance from the aisle. The adjustable length of the front and rear members 32, 34 allows the hooked display rack to be supported between posts 22 spaced a variable distance apart. The ability to release and refasten clamp 50 allows the display rack 24 to be positioned along the length of the upper and lower frames 26, 28, between posts 22. Moreover, the ability to remove the display rack 24 allows an entire rack to be removed and replaced.

When a new store is being set up, or stock being completely changed, hooked display racks 24 can be sent that already have merchandise 33 hanging on the hooks 52 of the racks or hanging on a majority of the hooks. Once the upper and lower frames 26, 28 are adjusted to the length between posts 22, and adjusted in depth to position the front members 32 and display rack 24 a desired distance from the aisle, then the display rack is fastened to the front members 32. The rack 24 could be fastened to the front members 32 first and then the position adjusted, but the rack hinders access to the members 36, 38 and to the mechanisms 42 sued to lock the members 36, 38 in position. The ability to quickly set up or replace an entire display rack 24 significantly reduces the time to change the merchandise on a display rack 24, and is significantly faster than installing an empty display rack 24 and then hanging the merchandise on the display rack. This not only allows a faster set-up when initially installing a new arrangement of merchandise in a store, but it also allows fast restocking because one or more entire display racks 24 can be removed and taken to an inventory control facility for replenishment at a more relaxed pace, and for accurate counting of the merchandise inventory on each display rack.

The adjustable length frames 26, 28 (via members 32, 34) thus provide a means for supporting a display rack 24 between posts 22, and provide a means for allowing the display rack 24 to be positioned at a desired location between the posts. The adjustable depth frames 26, 28 (via ends 36, 38) thus provides a means for positioning the display rack 24 a desired distance from the aisle. While the rack position is described relative to the aisle, that distance correlates to the distance of the front members 32 from the back members 34, because the geometry of the parts are known and predictable. The adjustability of the parts allows the adjustable display rack 20 to be reconfigured as desired, or to be removed and replaced with previously adjusted parts, with the removed parts being reconfigured and readjusted at a remote location where time is not of the essence and where it is easier to make the readjustments and reconfigurations.

Further, the extendable parts of the frames 26, 28 allow the frames to be compressed in length via members 32, 34, and compressed in depth, via ends 36, 38. Thus, an assembled frame 26, 28 can be reduced in size for shipment. Moreover, having releasable connections between ends 36, 38 and the members 32, 34 allows even the frames 26, 28 to be disassembled for shipment. There is thus advantageously provided a compact shipping configuration that reduces shipping size and cost.

Referring to FIG. 12, the display rack 24 may take various forms, sizes and shapes. The number of hooks 52 can vary, as can the number of rows and columns of such hooks, and the spacing of such rows and columns. Further, features can be added to improve the use of the display racks 24. The depicted embodiment has a plurality of bands 70 and a header 72. The bands 70 extend from the rods 56 forming the grid-work frame 54 of the rack, and extend around the distal ends of the hooks 52 on which merchandise is sold. The bands 70 provide a space near a plurality of the hooks 52 on which printed indicia, such as information about the merchandise, can be placed. As the band 70 is preferably horizontal, it provides a convenient location to provide information on the merchandise 33 (FIG. 1) that is supported by one horizontal row of hooks 52.

The header 72 is also connected to the display rack 24. The header 72 is shown fastened to the grid-work frame 54 at the back of the display rack 24, but could be located at the front of the display rack 24 either by forming extensions on the grid work frame 54, or by fastening the header to the bands 70, or by other known means. The header also provides a surface for product information, and is usually information common to the entire display rack 24, although it need not be so.

FIG. 12 also shows a pair of vertically aligned channels 74 each having a C-shaped cross-section which opens toward each other. The channels 74 allow the edges of a panel 76 to be placed in the channels so the channels hold and/or support the panel. If the panel 76 is of thin cardboard, the support from channels 74 will keep the panel from buckling or otherwise unacceptably deforming. The lower ends of the channels 74 are blocked or another form of motion stop is fastened to the rack 24 to prevent the panel 76 from sliding to the ground. The panel 76 can provide information on each type of merchandise associated with each display hook 52. Because the panel 76 is at the back of the hooked display rack 24, the information may be more readily visible when one or more of the hooks 52 have no merchandise on them. The panel is thus especially useful for containing vendor or store information used to restock the display panel 24, but other consumer-usable information could also be provided.

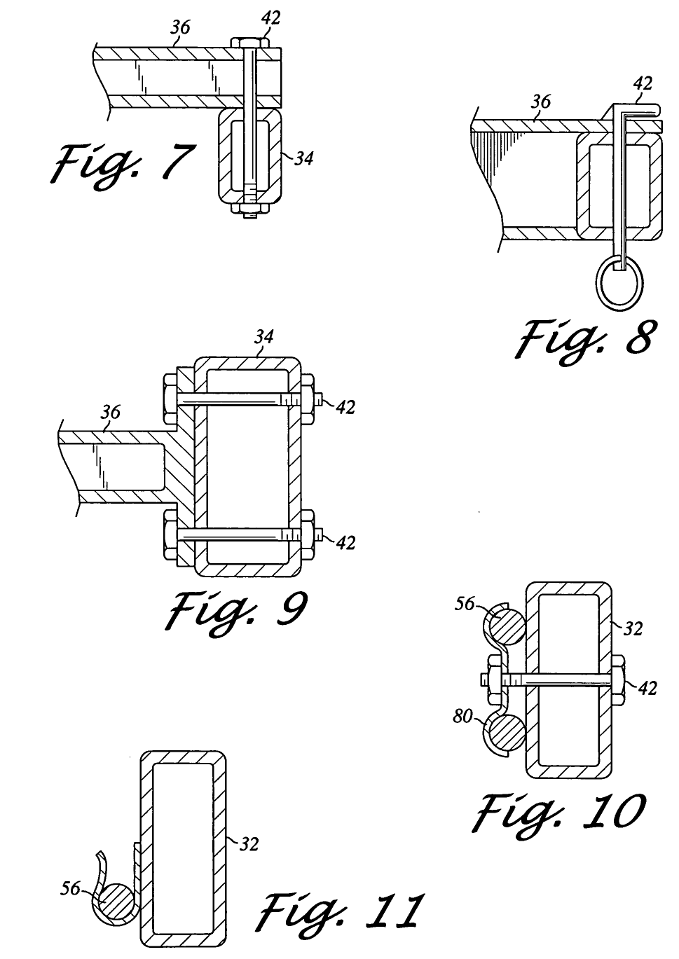

Referring to FIGS. 7-9, alternative ways are shown for fastening the extendable end members 36, 38 to the front and back members 32, 34. In FIG. 7, the end member 36 is placed on top of the end member 34, and a fastener 42, such as bolt, extends through those members to fasten them together. In FIG. 8, a flange on the top of the end member 36 extends over the top of the back member 34 and a fastener extends through those members to fasten them together. In FIG. 9, a distal end of end bracket 36 has a flange which is bolted through the side of the back member 34. These and other ways can be used to removably fasten one or both distal ends of the end members 36, 38 to the front and back members 32, 34.

FIG. 6 shows a further embodiment in which a portion of an end member 36 is welded or integrally formed with a distal end of one of front or back members 32, 34. The parts could be extruded and then welded to form a single part, or they could be molded into the desired configuration.

Referring to FIG. 10, a further embodiment for releasably fastening the display rack 24 to the front member 32 is shown. A bracket 80 having a portion extending across one or more rods 56 of the display rack is removably fastened to the front member 32. A fastener 42 comprising a bolt is believed suitable. Advantageously the bracket 80 has a portion curved to fit the contour of the abutting portion of rod 56, but that need not be so. The bracket 80 can be a flat, elongated member.

FIG. 11 shows a partial sectional view of a further embodiment for releasably connecting the hooked display rack 24 to adjustable frame 26, 28 using a resilient snap-lock 82 bracket. The snap-lock 82 is shown as a U-shaped piece of resilient material, such as plastic or spring steel, and has one leg of the U fastened to the front member 32, as by welding, or threaded fasteners. The bottom of the U shaped snap-lock 82 is advantageously larger in cross section than the space between the distal ends of the U shaped snap-lock 82. Advantageously, the leg of the U-shaped member that is not fastened to the front bracket 82 is curved slightly away from the bracket 82 to make it easier to slip the rod 56 between the legs of the U, and into the bottom of the bracket 82. The narrow opening resists removal of the rod 56 from the snap-lock bracket 82. A plurality of such snap-locks 82 fastened to the front member(s) 32 allows variable positioning of the display bracket 24 on the adjustable frames 26, 28. Lest sophisticated shapes of the bracket 82 can be used in which the distal portion of the bracket is punched out of the front member 32.

Other types of display racks 24 can be used, and the display racks need not use hooks 52. Thus shelves or ledges could be supported on the cantilevered, adjustable frames 26, 28. But such shelves are more readily loaded with merchandise than hooked display racks so the present method and apparatus are especially suited toward the hooked display racks. Further, while the length of front and back members 32, 34 is adjustable, it is suitable in limited situations to have the lengths fixed, and have only the end members 36, 38 of adjustable length. Moreover, while the adjustable frames 26, 28 are advantageously each in a parallel plane, and preferably each in a horizontal plane, one or both frames 26, 28 could be inclined so the front and rear members 32, 34 are offset vertically, with the end members 36, 38 are inclined.

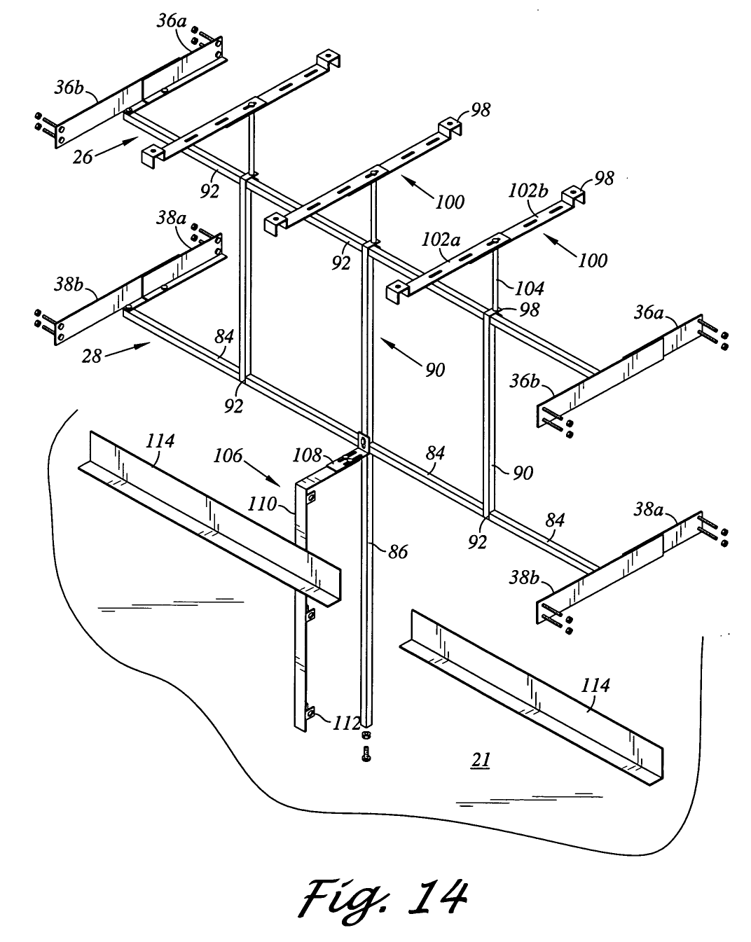

Referring to FIGS. 13-14 a further embodiment of upper and lower adjustable frames is shown. Instead of front and rear adjustable frames 26, 28, a single, central frame 84 is used along with a lower, floor support 86, an upper support 88, an interconnecting brace 90 and which uses open sections on the adjustable length end members 36, 38. For ease of illustration only a portion of the frames are shown in FIG. 13, with the left side being shown, and the right side being a mirror image of the left side, along the length of the lower support 86, as shown in FIG. 14.

In this embodiment the end members 36, 38 comprise adjustable length brackets with an open cross-section rather than a closed cross-section. While the members 36, 38 could be flat plates, the members each preferably have an L-shaped cross section along at least a portion of the length of the member. As shown the outer end member 36b has a vertically oriented plate or strip of metal with holes in its front, distal end so to fasten to the front post or support 22b (FIG. 1). In this embodiment threaded fasteners such as bolts are used to fasten the end members 36, 38 to the posts 22, but various fastening mechanisms could be used. The rear portion of the outer end member 36b preferably has a horizontal flange on the lower edge so the member 36b has an L-shaped cross-section. The inner member 36a has a corresponding, mating L-shaped cross-section so it can nest against the outer member 36b. Mating holes in the inner and outer end members 36a, 36b allow the length of the end member 36 to be adjusted, with threaded fasteners such as bolts holding the parts together when the desired length is achieved. The supports 22a, 22b are typically 24 or 36 inches apart, and lengths and holes can be adjusted accordingly. Holes in the rear member 36b allow fastening to the rear support 22a (FIG. 1) using threaded fasteners.

The use of plates and flanges forming L-sections allows a lighter support structure than the closed section members shown earlier. The use of the horizontal flange provides a stiffer and stronger end member 36, transfers the forces better than merely having two flat plates fastened together, and provides easier alignment of the parts.

The opposing end member 38 is similarly constructed and will not be described in order to avoid repetition. The end members 36, 38 thus have vertically oriented, facing plates, with horizontal flanges extending toward each other. The holes in the end members 36, 38 are advantageously circular holes placed at periodic intervals because the distance between supports 22a, 22b is usually at fixed and known increments so the parts can be bolted together to achieve a sufficiently strong support. But one or more of the aligned holes could be slotted to provide for an infinitely adjustable length.

Extending between opposing end members is a central support member 84, which advantageously has a closed cross-section to better resist torsion loads, but which could have an open section. Advantageously a smaller cross-section can be used, and a square or circular cross-section is preferred. The central support member or frame 84 is preferably of adjustable length as previously disclosed, with various numbers of support segments fastened to each other, or to a connector described later.

Advantageously, but optionally, a vertical support is placed between the end members 36, 38 and the central frame 84 fastens to that vertical support. The vertical support includes an elongated floor support 86 which has a first end configured and located to abut the floor 21 (FIG. 1). An adjustable length foot can be used by putting a desired head on the end of a threaded bolt extending along the length of the support 86 and engaging a threaded support in the lower end of the support 86. An opposing, second end of the floor support 86 is fastened to a connector 92. The vertical floor support 86 is preferably of the same cross-section shape as the central frame 84, and is shows with a square cross-section.

The connector 92 can be a two, three or four-way connector, with the floor support 86 connecting to a four-way connector that is shaped like a cross with four short arms at right angles to each other, but in the same plane. Two opposing, horizontal arms 94 fasten to a central frame 84 on each side of the connector 92. Two opposing, vertical arms 96 fasten to vertical supports 86, 90. The arms 94, 96 on the connector 92 preferably have the same cross-sectional shape as the mating portions of the frame 84, support 89 or brace 90, and thus can nest inside, or outside the mating member.

The depicted connector 92 advantageously has a cross-section on the arms 94, 96 which fits inside the cross-section of the floor support 86 and the cross-section of the center frame 94 and the cross-section of the brace 90. Preferably the cross-section is square as are the mating cross-sections. But a lighter assembly can be achieved by using a C-shaped cross-section, with the rear, vertical section being open. One or more holes are provided in the arms 94, 96 and in the mating ends of the center frame members 84, lower support 86 and brace 90 to fasten the parts together. Threaded fasteners are preferred, but spring loaded detents, or pins could also be used, as could other fastening mechanisms. Elongated slots are preferred over fixed interval holes in the arms 94, 96 in order to allow for more adjustability. The connectors advantageously have the mating arm 96 welded to the braces 90. A connector 92 could also be welded to the floor supports 86.

The brace 90 has a lower end preferably, but optionally configured to nest with one of the arms 96 of the connector 92 located on the lower adjustable frame 28. An upper end of the brace 90 has a connector fitting 98 configured to mate with the elongated central frame 84 or with another connector 92 each of which are located on the upper frame 26.

In the depicted embodiment the fitting 98 comprises a C-shaped flange that opens horizontally so a horizontally oriented, two-way connector 92 can fit between the opposing legs of the C. A threaded fastener or pin can then be placed through the distal ends of the legs forming the C in order to trap the frame 84 in the C and to resist disconnecting the fitting and the central frame. Alternatively, the fitting 98 can be bolted to the central frame 84. Various shaped brackets can be used to connect these parts.

The fitting 98 advantageously fastens to a two-sided connector 92. One horizontal arm 94 fastens to a central frame 84 on the upper adjustable frame 26, and the opposing arm 94 fastens to a different portion of the central frame 84 also on the adjustable upper frame 26. The fitting 98 could be omitted, and the upper end of the brace 90 could simply nest into a three way connector 92 which has a single arm 96 depending downward and nesting inside the brace 90. Holes and/or slots can be used with fasteners as previously described to fasten the parts and allow adjustment of the lengths.

A desired number of connectors 92 can be used to achieve the desired length of the upper and lower frames 26, 28. The distal ends of the central frames 84 are then fastened to the mating portions of the end members 36, 38 (not shown). Preferably a distal end of the central frame 84 abuts the horizontal flange on the adjustable end member 36a and is fastened thereto. Passing a fastener such as a bolt or pin through aligned holes in the parts is believed suitable. Advantageously the fastener passes through both end members 36a, 36b to help fix the length. In the illustrated embodiment the center frame 84 fastens to the end member 36b at the front end, which is located about the middle of the end frame 36.

Any number of central frames 84 can be vertically aligned and vertically separated and supported by inter-frame braces 90 and connectors 92 and/or fittings 98. Two parallel central frames 84 are shown on each side of the lower support 86, but more could be used. Further, the floor support 86 could be used with all, or none, of the braces 90 that fasten to the lower-most frame 28.

The upper support frame 26 can also be supported if desired. The top ends of supports 22 will sometimes have elongated members extending along the length of the aisle and connecting adjacent supports or posts 22. These top support members run parallel to the ceiling, and are thus generally parallel to the length of the horizontal central frame 84. An adjustable top brace 100 is advantageously formed by overlapping straps 102a, 102b. Each strap 102 has holes configured to overlap so a fastener (e.g., bolt, pin, etc.) can pass through the aligned holes to secure the parts together. Slots can be used as desired to provide a larger range of adjustability than holes. Each strap 102a, 102b has one distal comprising a fitting configured to fasten to the top support extending between posts 22. The fittings advantageously comprise fittings 98, and preferably have a C-shaped fitting having two opposing legs that fit on opposing sides of an elongated support member.

An adjustable length connector 104 connects the top brace 100 to the upper frame 26. Preferably the connector 104 comprises a threaded rod that passes through aligned holes in straps 102a, 102b and is fastened to the top brace 100 by a nut. The opposing end of the threaded rod 104 could engage mating threads in one of the central frame members 84, or in the fitting 98, or in the connector 92. Advantageously the top brace 100 is vertically aligned with one or more braces 90 and with floor support 86 to provide a continuous vertical support from floor to ceiling. The top brace 100 and its adjustable-length connection 104 with the upper support member 84 can take various forms and configurations which will be known to one skilled in the art given the disclosures herein.

Referring to the lower frame 28, a second brace 90 is shown with a C-shaped fitting 98 fastened to the upper frame 26 and the lower end of the brace 90 fastened to the lower frame 28 through a three-way connector 92. The three-way connector 92 has two opposing horizontal arms 24 and a vertical arm 96 (not shown) that nests with the lower end of the mating brace 90. As the vertical arm 96 is inside the brace 90 the arm 96 is not shown. Other types of connections could be used, including fitting 98.

The central frame members 84 and connectors 92 thus provide a means for adjusting the length of the upper and lower frames 26, 28. The braces 90 and connectors 92 and/or fittings 98 provide means for interconnecting the upper and lower frames 26, 28. The braces 90 help further support and strengthen the frames 26, 28.

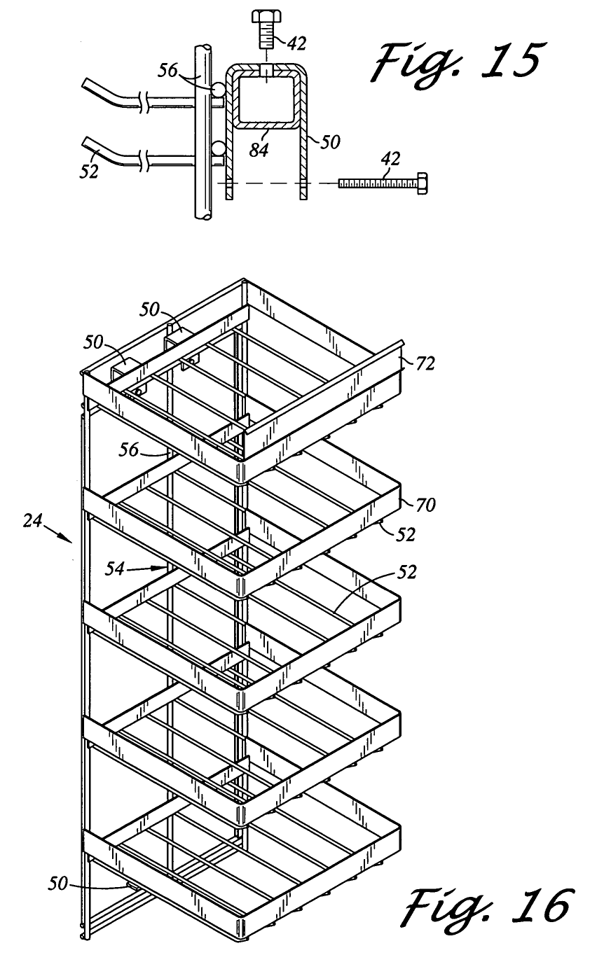

Referring further to FIGS. 15-16, the hooked display rack 24 has C-shaped clamps 50 that fit over opposing sides of the central frame 84. But in the depicted embodiment the C-shaped clamps 50 open downward so the closed portion of the clamp rests against the top of the frame 50. A fastener 42 can then fasten the clamp 50 to the central frame 84, or the fastener can extend between adjacent portions of the clamp in order to prevent removal of the clamp 50 (and frame 24) from the frame 84.

Referring to FIG. 16, in this further embodiment the header display 72 is placed at the front of the display rack. In use the length of the end frames 36, 38 is adjusted to extend between two adjacent supports 22a, 22b and the end frames are fastened to those supports. The central frame is then placed along the length of the end frames 36, 38 so the distal ends 52 of the hooks is at about the aisle, and preferably slightly back of that portion of support 22b which faces the aisle. The length of the central frame 84 is then adjusted to extend between the end members 36, 38, and the frame is fastened to the end members. This is done for the upper frame 26, the lower frame 28, and any additional frames. Floor supports 86 and ceiling supports or top supports 100 are added as desired. The display rack 24 is then fastened to the frame 84 by clamps 50 which preferably, but optionally engage upper and lower frames 26, 28. FIG. 16 shows two upper clamps 50 and one, centrally located lower bracket 20. Fasteners 42 then releasably lock the frame 24 to the frames 26, 28 as described relative to FIG. 15.

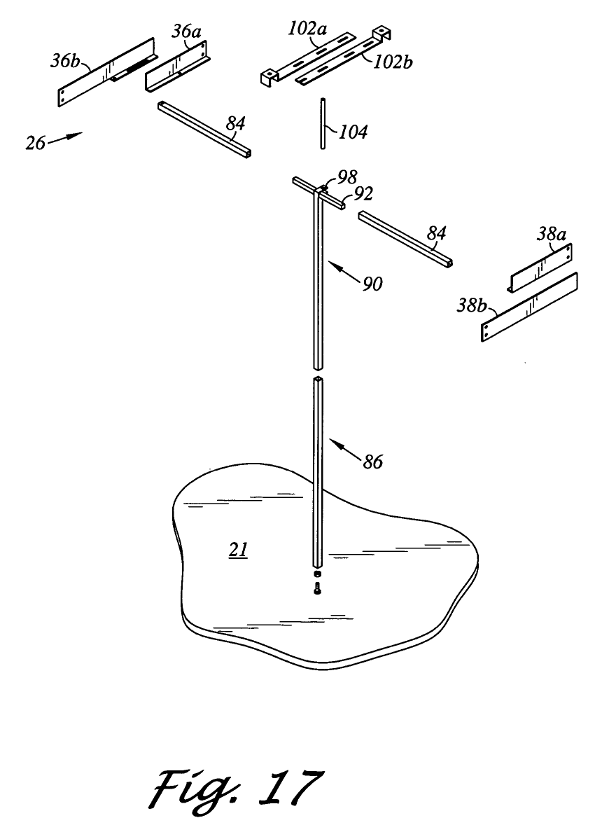

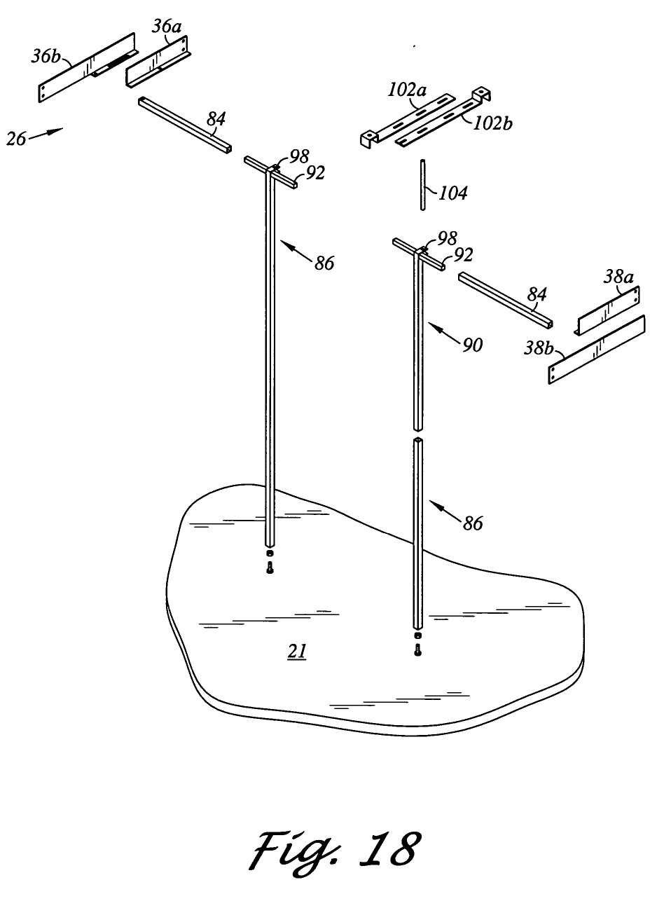

Referring to FIGS. 16-17, in a further embodiment the lower frame 28 could be omitted, with the adjustable upper frame 26 being located at the desired distance from the aisle, or from the plane defined by the front of the two adjacent supports 22b (FIG. 1), or alternatively from the plane defined by the rear of the two adjacent supports 22a (FIG. 1). The lower support 86, and optionally a brace 90 support the upper frame 26 off the floor 21 (FIGS. 1, 14). A top brace 100 connected to a fastener 104 extending along the longitudinal axis of lower support 86 preferably, but optionally further supports the upper frame 26. The display rack 24 (FIG. 16) has two clamps 50 or other fastening mechanisms connected to the upper support frame 26 on opposing sides of the longitudinal axis extending through the lower support 86 and brace 90 (FIG. 17). The display rack 24 also has a single, lower clamp 50 (FIG. 16) that is centrally located and configured to engage the lower support 86 (FIG. 17). The three clamps 50 define a plane and support the display rack 24.

Referring to FIGS. 13-14, occasionally it is desirable to have chests or drawers below the display rack. A mounting bracket 106 is provided so any chests or drawers etc can be fastened to the frame 26, 28. The bracket 106 has an upper portion 108 configured to abut and fasten to one or more of the lower support 86, connector 92, central frame 84 or brace 90. The upper portion 108 is shown as an L-shaped strip of metal with holes in the vertical leg to bolt it or otherwise fasten it to one of the lower support 86, connector 92, central frame 84, or brace 90. There are slots in the horizontal leg which align with corresponding slots in a lower portion 110. The lower portion is also L shaped, with a relatively short horizontal portion and a longer vertical portion. The overlapping slots on the horizontal portions of brackets 108, 110 allow relative movement of the lower portion 110 toward and away from the aisle with one or more fasteners extending through the slots to fasten the parts together when the desired location of the lower portion 110 relative to the aisle is reached. The desired location is preferably the location which places any chests, boxes etc. that are fastened to the bracket, at a desired location relative to the aisle.

The vertical leg of the lower portion 110 has a plurality of mounting tabs 112 extending away from the aisle. The mounting tabs 112 have holes or slots in them so a chest, a set of drawers, a box, or another item can be fastened to the lower portion 110 of bracket 106 using tabs 112. The end of the front portion 110 may abut the floor 21 (FIG. 1) or it may be adjacent the floor. The end of the front portion 110 may be fastened to the floor, or it may be fastened to the lower leg 89 by another adjustable bracket 108, in which case the front portion becomes C shaped with a second horizontal leg on the lower end of the front portion 110 constructed like the depicted horizontal leg on the upper end.

Referring to FIG. 14, if a chest, a set of drawers, a box, or another item is placed below the display rack 24, then advantageously a backstop 114 is also provided. The backstop 12 comprises an elongated member with an L shaped cross section. Angle iron could be used. The backstop 12 is fastened to the floor 21 by adhesives, or by nails or other means known in the art, at a location that limits the movement of the chest or other item relative to the aisle at a desired location. The chest simply abuts the backstop 114.

A still further variation is described relative to FIGS. 1-2 and 13-14. The end members 36, 38 are of fixed length selected to extend between and fasten to the vertical posts or supports 22a, 22b, which are typically either 24 or 36 inches apart. Thus, the end members 36, 38 are of predetermined length, not adjustable in length, and have ends configured to be fastened to the supports 22a, 22b. The end members 36, 38 have a plurality of mounting holes in them so the front and rear members 32, 34 or central frame 84 can be fastened at a desired location along the length of the end members 36, 38 to place the ends of the display rods 52 at a desired distance relative to the aisle, or relative to the front edge of the support 22b, and preferably about the same as or behind that front edge of the support 22b. The length of the members 32, 34, 84 is adjustable to extend between adjacent posts 22b, 22b and 22a, 22a spaced along the aisle. This is done for both the upper and lower frames 26, 28 modified as described relative to this further embodiment. The display racks 24 may be mounted to the members 32, 34, 84, using clamps 50 or other removable mounting mechanisms.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The above description is given by way of example, and not limitation. Given the above disclosure, one skilled in the art could devise variations that are within the scope and spirit of the invention, including various ways of fastening or connecting the display rack 24 to the front member(s) 32 of the upper and/or lower adjustable frames 26, 28, or for removably fastening the end members 36, 38 to the front and back members 32, 34, respectively. Further, the various features of this invention can be used alone, or in varying combinations with each other and are not intended to be limited to the specific combination described herein. In particular, the length of various parts can be adjusted in various sequences and can be fastened together in various sequences, and unless specifically stated the order of assembly is not confined to a particular sequence. Thus, the invention is not to be limited by the illustrated embodiments but is to be defined by the following claims when read in the broadest reasonable manner to preserve the validity of the claims.

1. A display rack for displaying items, the display rack being located between two pair of posts with each pair having a front and rear post and each pair being spaced apart along a first axis extending between the front posts and along an aisle adjacent the front post, with the rear post being set back from the aisle along a second axis generally perpendicular to the first axis, comprising:
an upper and lower frame each having two opposing end members aligned parallel to the second axis, each end member having an adjustable length along a longitudinal axis of the respective end member and each of which has an outer end member and an inner end member nested at least partially inside the outer end member and movable along the longitudinal axis of the end member to adjust the length of the end member along the second axis, each end member having two distal ends one of which is configured to fasten to the front post and the other of which is configured to fasten to the rear post during use of the display rack;
each upper and lower frame further having an elongated support member aligned parallel to the first axis and formed of a first and second support segment nested at least partially with one of a connector connecting the segments or nested with the other support segment, the nesting providing an adjustable length of the support member, each support member having two opposed ends each of which is fastened to a different one of the end members on the upper frame or the end members on the lower frame; and
a display rack having a display rack frame releasably fastened to the support member of the upper and lower frames, the display rack having a plurality of hooks extending from the display rack to hold the items for display during use of the display rack, wherein the location of the support member on the end members varies the position of the hooks along the second axis.

2. The display rack of claim 1, wherein the support segments fasten to one of two opposing arms of the connector, the connector having a third arm forming a brace extending between and fastened to the upper and lower frames.

3. The display rack of claim 2, wherein the support segments nestle with one of the two opposing arms of the connector and wherein at least one of the support segments and connector arms have a plurality of holes which align with a hole in the other of the support segments and connector arms to adjust the length of the support, with a fastener inserted through the aligned holes to lock the support segments to the arms.

4. The display rack of claim 1, wherein the support segments nestle with one of two opposing arms of the connector, the connector having a third arm forming a brace extending between and fastened to the upper and lower frames, the connector having a fourth arm forming a lower support that extends from the lower frame to the floor.

5. The display rack of claim 4, wherein at least one of the support segments and connector arms have a plurality of holes which align with a hole in the other of the support segments and connector arms to adjust the length of the support, with a fastener inserted through the aligned holes to fasten the support segments to the arms, and wherein the third arm and brace have a plurality of holes at least some of which align to allow passage of a fastener to vary the length of the brace and lock that length by insertion of the fastener.

6. The display rack of claim 1, wherein the support segments nestle with one of two opposing arms of the connector, the connector having a further arm forming a lower support that extends from the lower frame to the floor.

7. The display rack of claim 1, wherein the upper and lower frames further comprise end members having open cross-sections.

8. The display rack of claim 1, wherein the upper and lower frames further comprise end members having closed cross-sections.

9. The display rack of claim 1, wherein the hooks are permanently fastened to the display rack frame.

10. The display rack of claim 1, wherein each support segment nests with another support segment to form the support member, and further comprising two parallel support members spaced apart along the second axis to form front and rear support members on each of the upper and lower frames, the display rack being fastened to each of the front support members.

11. The display rack of claim 1, further comprising a brace extending between and releasably fastened to the upper and lower frames.

12. The display rack of claim 1, further comprising a lower support extending between and releasably fastened to the upper and lower frames.

13. The display rack of claim 1, further comprising a top brace aligned parallel to the second axis and located above the upper support member, an adjustable length member extending between the top brace and the upper support member to fasten the top brace to the upper support member.

14. A kit for assembling a display rack used to display items, the display rack located between two pair of posts with each pair having a front and rear post and each pair being spaced apart along a first axis extending between the front posts, with the rear post being set back from the first post along a second axis generally perpendicular to the first axis, the kit comprising:
a display rack having a display rack frame having upper and lower connectors on the frame, the rack having a plurality of hooks extending from the display rack with merchandise on a majority of the hooks of the display rack;
an upper frame comprising:
two opposing upper end members, each upper end member having an adjustable length along a longitudinal axis of the respective upper end member provided by an outer end member and an inner member nested at least partially inside the outer end member and movable along the longitudinal axis of the upper end member to adjust the length of the upper end member, each upper end member having two distal ends one of which is configured to fasten to the front post and the other of which is configured to fasten to the rear post during use of the kit;
an upper elongated support having at least a first and second upper support segment each nested at least partially with one of an upper connector connecting the segments or nested with the other support segment, the nesting providing an adjustable length of the upper support by use of a fastener passing through overlapping holes in the nested parts to lock the parts together, each upper elongated support having two opposed ends each of which is configured to fasten to a different one of the upper end members;
a lower frame comprising:
two opposing lower end members, each lower end member having an adjustable length along a longitudinal axis of the respective lower end member provided by an outer end member and an inner member nested at least partially inside the outer end member and movable along the longitudinal axis of the lower end member to adjust the length of the lower end member, each lower end member having two distal ends one of which is configured to fasten to the front post and the other of which is configured to fasten to the rear post during use of the kit;
a lower elongated support having at least a first and second lower support segment each nested at least partially with one of a lower connector connecting the lower support segments or nested with the other lower support segment, the nesting providing an adjustable length of the lower support member by use of a fastener passing through overlapping holes in the nested parts to lock the parts together, each elongated lower support having two opposed ends each of which is configured to fasten to a different one of the end members on the lower frame.

15. The display rack of claim 14, wherein the kit includes the upper and lower connectors each having opposing arms configured to adjustably fasten to the support segments, each connector having a third arm and further including a brace sized to extend between the upper and lower connector and having opposing ends configured to fasten to the third arm of each connector.

16. The display rack of claim 14, wherein the kit includes the lower connector which has opposing arms configured to adjustably fasten to the lower support segments and having a third arm, and further including a lower support having an end configured to fasten to the third arm and having a length sized to extend from the lower support to the floor during use of the kit.

17. The display rack of claim 14, wherein the kit includes the upper and lower connectors each having opposing arms configured to adjustably fasten to the support segments, each connector having a third arm and further including a brace sized to extend between the upper and lower connector and having opposing ends configured to fasten to the third arm of each connector, the lower connector having a fourth arm and further including a lower support having an end configured to fasten to the fourth arm and having a length sized to extend from the lower support to the floor during use of the kit.

18. The display rack of claim 14, wherein first and second frame each has two support members.

19. The display rack of claim 14, wherein at least some of the connectors and support segments have a plurality of holes extending therethrough with at least some of the plurality of holes located to align with a hole in one of the connectors or segments to allow passage of a fastener, and further comprising a fastener extending through the aligned holes to hold the parts with the aligned holes through which the fastener passes at a selected length.

20. The display rack of claim 14, further comprising means for releasably locking the supports and connectors at a selected length.

21. The display rack of claim 14, wherein a top support extends between the front posts, and the display rack comprises a top brace aligned parallel to the second axis and located above the upper support member, an adjustable length member extending between the top brace and the upper support member to fasten the top brace to the upper support member, the top brace having at least one distal end configured to fasten to the top support during use of the display rack.

22. A display rack used to display items, the display rack located between two pair of posts extending from a floor, each pair having a front and rear post and each pair being spaced apart along a first axis extending along an aisle adjacent the front post, with the rear post being set back from the aisle along a second axis generally perpendicular to the first axis, the kit, comprising:
an upper frame including:
a pair of upper end members each having one end adapted to connect to the front post and an opposing end adapted to connect to the rear post, and means for varying the length of each upper end member;
an upper support member having opposing ends each of which is adapted to fasten to a different one of the upper end members and means for varying the length of the upper support member;
a lower frame including:
a pair of lower end members each having one end adapted to connect to the front post and an opposing end adapted to connect to the back post, and means for varying the length of each lower end member;
an lower support member having opposing ends each of which is adapted to fasten to a different one of the upper end members and means for varying the length of the lower support member; and
a display rack having a plurality of hooks with merchandise on a plurality of the hooks, and means for fastening the display rack to the upper and lower support members.

23. The display rack of claim 22, further comprising a brace having opposing ends each configured to connect to a different one of the upper and lower support members.

24. The display rack of claim 22, further comprising a lower support having one distal end configured to connect to the lower support and a length sufficient to extend from the lower support to the floor during use of the kit, and means for varying the length of the lower support member.

25. The display rack of claim 22, wherein at least one of the upper and lower support members has a connector with at least three arms two of which are configured to fasten to one of the support members.

26. The display rack of claim 22, wherein the upper and lower end members are releasably connected to the front and rear posts.

27. The display rack of claim 22, wherein the upper frame comprises a front and rear support each having opposing ends adapted to fasten to a different one of the upper end members and means for varying a length of the front and rear upper support members, and wherein the lower frame comprises a front and rear extendable support each having opposing ends adapted to fasten to a different one of the upper end members and means for varying the length of the front and rear lower support members.

28. The display rack of claim 22, wherein a top support extends between the front posts, and the display rack comprises a top brace aligned parallel to the second axis and located above the upper support member, an adjustable length member extending between the top brace and the upper support member to fasten the top brace to the upper support member, the top brace having at least one distal end configured to fasten to the top support during use of the display rack.

29. A method for positioning a display rack between a first and second pair of posts extending from a floor, each pair having a front and rear post and each pair being spaced apart along a first axis extending along an aisle adjacent the front post, with the rear post being set back from the aisle along a second axis generally perpendicular to the first axis, comprising:
adjusting a length of a first upper end member to extend between the first pair of posts and fastening the first upper end member to different ones of the front and rear posts, the first upper end member having two nested parts that slide relative to each other to vary the length of the first upper end member;
adjusting a length of a second upper end member to extend between the second pair of posts and fastening the second upper end member to the front and rear posts of the second pair, the second upper end member having two nested parts that slide relative to each other to vary the length of the second upper end member;
adjusting a length of an upper support member to extend between the first and second upper end members and removably fastening the upper support member to the upper support members;
adjusting a length of a first lower end member to extend between the first pair of posts and removably fastening the first lower end member to the front and rear posts of that first pair, the first lower end member having two nested parts that slide relative to each other to vary the length of the first lower end member;
adjusting a length of a second lower end member to extend between the second pair of posts and removably fastening the second upper end member to the front and rear posts of that second pair, the second lower end member having two nested parts that slide relative to each other to vary the length of the second lower end member;
adjusting a length of a lower support member to extend between the first and second lower end members and removably fastening the lower support member to the lower support members, the lower support member having two nested parts that slide relative to each other to vary the length of the lower support member;
removably fastening the display rack to each of the support members, the display rack having hooks thereon with merchandise on a majority of the hooks when the display rack is fastened to the support members.

30. The method of claim 29, further comprising locking the length of the end members and support members after the length of each member is adjusted.

31. The method of claim 29, further comprising removably fastening a brace between the upper and lower supports.

32. The method of claim 29, further comprising removably fastening a brace between the upper and lower supports and removably fastening a lower support to the lower support frame, the lower support extending between the floor and the lower support frame.

33. The method of claim 29, further comprising removably fastening a lower support to the lower support frame, the lower support extending between the floor and the lower support frame.

34. The method of claim 29, further comprising adjusting the location of the upper and lower support members along the length of the end members to position the display rack relative to the front posts.

35. The method of claim 29, further comprising:
adjusting a length of a rear upper support member to extend between the upper end members and removably fastening the upper rear support member to the upper end members; and
adjusting a length of a rear lower support member to extend between the lower end members and removably fastening the lower rear support member to the upper end members.

36. The method of claim 29, further comprising the step of fastening a second display rack to the upper and lower support members, the second display rack having hooks thereon with merchandise on a majority of the hooks when the second display rack is fastened to the support members.

37. The method of claim 29, wherein a top support extends between a top of the front posts, and the method further comprises releasably fastening the upper support member to the top support.

38. A method of stocking merchandise on a display rack supported between a first and second pair of posts extending from a floor, each pair having a front and rear post and each pair being spaced apart along a first axis extending along an aisle adjacent the front post, with the rear post being set back from the aisle along a second axis generally perpendicular to the first axis, comprising:
placing merchandise on the display rack at a location outside the store;
adjusting a length of first upper and lower end members to extend between the first pair of posts and releasably fastening the first upper and lower end members to the first pair of posts;
adjusting a length of second upper and lower end member to extend between the second pair of posts and releasably fastening the second upper and lower end members to the second pair of posts;
adjusting a length of upper and lower support members to extend between the respective upper and lower end members and releasably fastening the support members to the respective end members; and
attaching the display rack to the upper and lower support members.

39. The method of claim 38, further comprising locking the length of the end members and the upper and lower support members after the length is adjusted.

40. The method of claim 38, further comprising adjusting a location of the upper and lower support members along the length of the end members before the display rack is fastened to the support members to position the display rack relative to the front posts.

41. The method of claim 40, further comprising adjusting a location of the upper and lower support members along the length of the end members after the display rack is fastened to the support members to position the display rack relative to the front posts.

42. The method of claim 40, wherein a top support extends between a top of the front posts, and the method further comprises releasably fastening the upper support member to the top support.

43. The method of claim 40, wherein a top support fastens to the upper support member at the location where a brace extends between the upper and lower support members, with a lower support extending from the lower support member to the floor at the location where the brace fastens to the lower support member.
